(19) United States
(12) Patent Application Publication
(10) Pub. No.: US 2015/0286216 A1
(43) Pub. Date: Oct. 8, 2015

(54) CONVEYANCE DEVICE AND CONTROL METHOD FOR FLIGHT VEHICLE

(71) Applicant: THE UNIVERSITY OF TOKUSHIMA, Tokushim-shi, Tokushima (JP)

(72) Inventor: Masafumi Miwa, Tokushima-shi (JP)

(21) Appl. No.: 14/439,969

(22) PCT Filed: Oct. 30, 2013
(86) PCT No.: PCT/JP2013/006444

§ 371 Date: Apr. 30, 2015

(30) Foreign Application Priority Data
Oct. 31, 2012 (JP) 2012-240559

(51) Int. Cl. G05D 1/00; G05B 6/02; B64C 39/02; G05D 1/02; G05D 1/08

(52) U.S. Cl. CPC G05D 1/0088; G05D 1/0202; G05D 1/0808; B64C 39/024; G05B 6/02; B64C 2201/024; B64C 2201/145; B64C 2201/128

(57) ABSTRACT

A control method for a flight vehicle having a plurality of lift sources, the control method includes switching, according to a command input force from external, a control function of the flight vehicle between a stationary control function that maintains a hovering state of the flight vehicle by controlling actuation of the lift sources, and a moving control function that detects the command input force to the flight vehicle and controls the actuation of the lift sources to realize movement of the flight vehicle in correspondence to the command input force.

### CROSS REFERENCE TO RELATED APPLICATIONS

This application is a national stage of International Application No.: PCT/JP2013/006444, which was filed on Oct. 30, 2013, and which claims priority to JP 2012-240559 which was filed on Oct. 31, 2012, and which are both herein incorporated by reference.

### TECHNICAL FIELD

The present invention relates to a conveyance device and a control method for a flight vehicle. More specifically, the present invention relates to a conveyance device that can three-dimensionally move an object and relates to a control method for a flight vehicle that can be adopted in the conveyance device.

### TECHNICAL BACKGROUND

Conventionally, as a device that conveys an object, a belt conveyor, a lifter, a dolly, a radio control helicopter or the like is used according to a purpose.

The belt conveyor can move an object between one end and the other end of the belt conveyor by placing the object on a belt and driving the belt. Further, in the case of the lifter such as an elevator, a wire or the like can be used to hang a lift and the lift can be vertically moved by winding the wire using a winch or the like. That is, an object can be placed on the lift, and the object can be vertically moved by winding the wire.

The above-described belt conveyor or the lifter can move an object in a stable state. However, there is a disadvantage that the object can only be moved along a path in which the belt or the lift is installed.

On the other hand, the dolly or the radio control helicopter is able to move itself and thus can freely select a path and a destination to convey an object.

For example, although the dolly having wheels and the like can only move along a ground surface or a floor surface, for movement along the ground surface or the floor surface, a path and a destination to convey an object can be freely selected. In addition, a human can directly operate the movement of the dolly by holding a handle or the like and thus the dolly can be simply operated.

On the other hand, the radio control helicopter can three-dimensionally move and thus can convey an object to a desired place via a desired path. In addition, the radio control helicopter can also hover in the air and thus can not only move the object but also hold the object in the air.

However, when an object is moved by the radio control helicopter, it is necessary to use a control device to remotely operate the radio control helicopter. In order to accurately control the radio control helicopter using the control device, it is necessary to become proficient with the operation of the control device. Therefore, it is difficult for everyone to easily perform conveyance of an object using the radio control helicopter as in the case of using the dolly on the ground.

In recent years, development of radio control helicopters has been progressing and improvements have been made in technologies for allowing a radio control helicopter to stay stationary at a predetermined position in a hovering state by automatic control. Further, a technology for stabilizing transition from a human-controlled movement state to an automatically controlled hovering state has also been developed (for example, Patent Document 1).

### RELATED ART

### Patent Document

[Patent Document 1] Japanese Patent Laid-Open Publication No. 2012-106721.

### SUMMARY OF THE INVENTION

### Problems to Be Solved by the Invention

However, in order for everyone to easily perform conveyance of an object using the radio control helicopter as in the case of using the dolly on the ground, it is necessary to enable the operation of the radio control helicopter during movement to be more easily performed. Even in the technology of Patent Document 1, in transition from a hovering state to a movement state and in the movement state, operations by a human are promised, and it is still difficult for everyone to operate the radio control helicopter easily.

The present invention is made in view of the above circumstances and intends to provide a control method for a flight vehicle that allows the flight vehicle to be simply operated without the need of learning operating skills and to provide a conveyance device that allows an object to be three-dimensionally moved by a flight vehicle that adopts the control method.

### Means for Solving the Problems

### (Control Method for Flight Vehicle)

A control method for a flight vehicle of the first invention having a plurality of lift sources, the control method comprising: switching, according to an input force from external, between a stationary control function that maintains a hovering state of the flight vehicle by controlling actuation of the plurality of the lift sources, and a moving control function that detects a direct input force to the flight vehicle and controls the actuation of the plurality of the lift sources to realize movement of the flight vehicle in correspondence to the input force.

In the control method for the flight vehicle of the second invention, according to the first invention, the direct input force to the flight vehicle is a force that changes a posture of the flight vehicle in the hovering state.

In the control method for the flight vehicle of the third invention, according to one of the first and second inventions, the stationary control function controls the actuation of the plurality of the lift sources to maintain the hovering state by PID control and the like, and the moving control function controls the actuation of the plurality of the lift sources to maintain the posture of the flight vehicle by PD control.

In the control method for the flight vehicle of the fourth invention, according to the second invention, the moving control function controls the actuation of the plurality of the lift sources according to at least one of a magnitude and a direction of the input force.

A conveyance device of the fifth invention that is a flight vehicle, comprising: a holding part that holds an object to be conveyed, a plurality of lift sources, and a control part that controls actuation of the plurality of the lift sources, wherein the control part includes: a stationary control function that maintains a hovering state by controlling the actuation of the plurality of the lift sources; a moving control function that controls the actuation of the plurality of the lift sources to realize movement of the flight vehicle in correspondence to an input force from external; and a switching function that switches control from the stationary control to the moving control according to the input force from the external.

In the conveyance device of the sixth invention, according to the fifth invention, the control part actuates the switching function and the moving control function according to the direct input force to the flight vehicle.

In the conveyance device of the seventh invention, according to the sixth invention, in a case where the input force due to touching the flight vehicle is a force that changes a posture of the flight vehicle in the hovering state,

In the conveyance device of the eighth invention, according to any one of the sixth and seventh inventions, the stationary control function controls the actuation of the plurality of the lift sources to maintain the hovering state by PID control and the like, and the moving control function controls the actuation of the plurality of the lift sources to maintain the posture of the flight vehicle by PD control.

In the conveyance device of the ninth invention, according to the sixth invention, the device further comprising an input detection part that detects the input force due to touching the flight vehicle. The moving control function controls the actuation of the plurality of the lift sources according to at least one of a magnitude and a direction of the input force that is detected by the input detection part.

In the conveyance device of the tenth invention, according to any one of the fifth to ninth inventions, the control part further has a GPS function that grasp a position of the flight vehicle, when the hovering state is maintained by stationary control function, a signal from the GPS function is used to control the actuation of the plurality of the lift sources, and when the flight vehicle is moved by the moving control function, the actuation of the plurality of the lift sources is controlled without using the signal from the GPS function.

In the conveyance device of the eleventh invention, according to any one of the fifth to tenth inventions, the flight vehicle is a multi-rotor helicopter of which the lift sources are rotors, the flight vehicle includes a cover frame that has rotor accommodating parts for accommodating the plurality of the rotors; and a frame body that supports the cover frame, and the frame body has a plurality of beams, one end of each of the beams being connected to an outer edge of the cover frame, and other ends of the beams being connected with each other.

### Effect of the Invention

### (Control Method for Flight Vehicle)

According to the first aspect of the invention, when the direct input is performed using a method such as touching the flight vehicle in a hovering state, based on the direct input, the actuation of the lift sources is controlled by the moving control function and the flight vehicle moves in correspondence to the input force. That is, by just touching the flight vehicle by a human, the movement of the flight vehicle can be operated. Therefore, the flight vehicle can be simply operated.

According to the second aspect of the invention, the flight vehicle can be moved by just changing the posture of the flight vehicle. Therefore, the flight vehicle can be simply and easily operated.

According to the third aspect of the invention, in the movement control, the posture of the flight vehicle is maintained by the PD control. Therefore, when a force is applied to change the posture of the flight vehicle in a hovering state, the flight vehicle is in a stable state in the posture that is changed from the hovering state. When the input force is removed from the state, the posture of the flight vehicle changes under the influence of the gravity such that the posture returns from the changed posture to the posture of the hovering state. Then, the flight vehicle moves in correspondence to a difference between the lifting forces in the state in which the posture has been changed and in the hovering state. Therefore, the flight vehicle can be moved by just changing the posture of the flight vehicle. Therefore, the flight vehicle can be simply and easily operated.

According to the fourth aspect of the invention, the movement distance and the movement direction of the flight vehicle can be operated by changing the size and/or the direction of the input force.

### (Conveyance Device)

According to the fifth aspect of the invention, when an external force is input to the flight vehicle in a hovering state, the control is switched by the switching function of the control part from the control by the stationary control function to the control by the moving control function. Then, by controlling the actuation of the lift sources by the moving control function based on the input force, the flight vehicle can be moved in correspondence to the input force. Therefore, when an object to be conveyed is held by the holding part, the object can be conveyed by the flight vehicle.

According to the sixth aspect of the invention, when the direct input is performed using a method such as touching the flight vehicle in a hovering state, based on the direct input, the moving control function controls the actuation of the lift sources and thus the flight vehicle can be moved in correspondence to the input force. That is, by just touching the flight vehicle by a human, the movement of the flight vehicle can be operated. Therefore, the flight vehicle can be simply operated.

According to the seventh aspect of the invention, the flight vehicle can be moved by just changing the posture of the flight vehicle. Therefore, the flight vehicle can be simply and easily operated.

According to the eighth aspect of the invention, in the movement control, the posture of the flight vehicle is maintained by the PD control. Therefore, when a force is applied to change the posture of the flight vehicle in a hovering state, the flight vehicle is in a stable state in the posture that is changed from the hovering state. When the input force is removed from the state, the posture of the flight vehicle changes under the influence of the gravity such that the posture returns from the changed posture to the posture of the hovering state. Then, the flight vehicle moves in correspondence to a difference between the lifting forces in the state in which the posture has been changed and in the hovering state. Therefore, the flight vehicle can be moved by just changing the posture of the flight vehicle. Therefore, the flight vehicle can be simply and easily operated.

According to the ninth aspect of the invention, the movement distance and the movement direction of the flight vehicle can be operated by changing the size and/or the direction of the input force.

According to the tenth aspect of the invention, the stationary control function uses a signal from the GPS function to control the actuation of the lift sources to maintain the hovering state. Therefore, the flight vehicle can be put in a more stable hovering state. On the other hand, in the state in which the control by the moving control function is performed, a signal from the GPS function is not used in the control of the actuation of the lift sources. Therefore, the flight vehicle can be smoothly moved.

According to the eleventh aspect of the invention, the plurality of the rotors are accommodated in the rotor accommodating parts of the cover frame. Therefore, the rotors can be prevented from being damaged by being in contact with a surrounding object. Further, the cover frame is supported by the beams. Therefore, even when an impact or the like is applied to the cover frame, the impact can be absorbed by the cover frame and the beams. Therefore, the cover frame can be prevented from being damaged.

Regarding basic technologies that are used for performing the invention, especially for the state feedback, the classic control, the modern control and the optimal control of vehicles, the followings are incorporated herein by reference.

K. Nonami, F. Kendoul, S. Suzuki, W. Wang, D. Nakazawa, “Autonomous Flying Robot”, ISBN 978-4-431-53855-4, Springer (2010)

K. Nonami, M. Kartidjo, K-J. Yoon, A. Budiyono, “Autonomous Control Systems and Vehicles” ISBN 978-4-431-54275-9, Springer (2013)

K Sato, Y shitamoto, N Nozawa, “HAJIMETE NO GENDAI SEIGYO RIRON (Modern Control Theory for Bigineers)” Kodansha, Ltd.

T Soeda, T Nakamizo, “JIDO SEIGYO NO KOUGI TO ENSYU (Lectures and Exercises on Autonomous Control)” Nisshin Publishing (1988)

### BRIEF DESCRIPTION OF THE DRAWINGS

FIG. 1A illustrates components of a conveyance device 1. FIG. 1B illustrates flow of actuation control of a conveyance device 1 by a control method for a flight vehicle of an embodiment.

FIGS. 2A and 2B are schematic explanatory diagrams of the conveyance device 1 of the present embodiment; FIG. 2A is a plan view; and FIG. 2B is a side view.

FIGS. 3A-3C describe operations that move the conveyance device 1 of the present embodiment and movement states due to the operations.

FIGS. 4A and 4B are schematic explanatory diagrams of a conveyance device 10 of another embodiment; FIG. 4A is a plan view; and FIG. 4B is a side view.

FIGS. 5A and 5B are schematic explanatory diagrams of a conveyance device 10 of another embodiment; FIG. 5A is a plan view; and FIG. 5B is a side view.

FIG. 6 is a cross-sectional view along a line II-II of FIG. 5B.

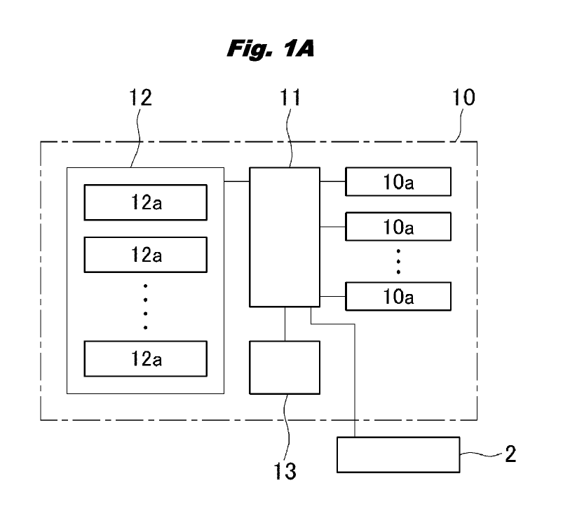

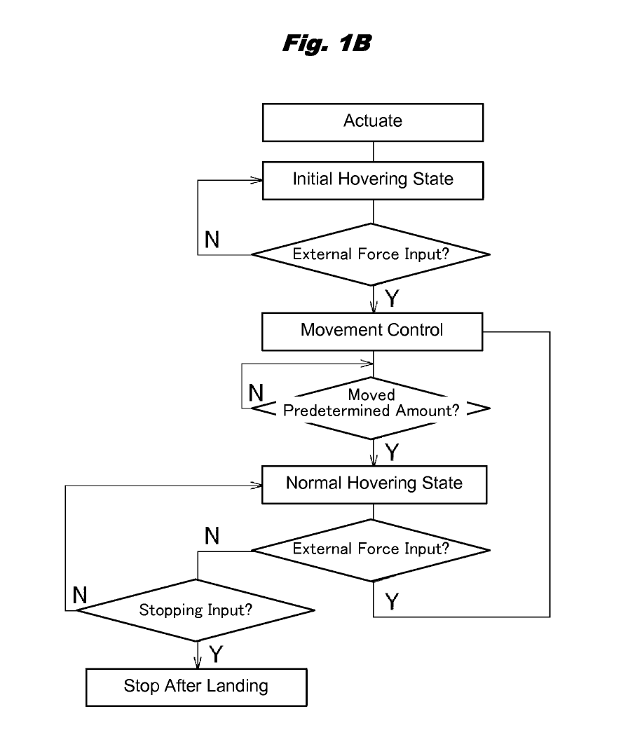

### EMBODIMENTS FOR CARRYING OUT THE INVENTION

Next, embodiments of the present invention are described based on the drawings. A control method for a flight vehicle of the present invention is a method for controlling a flight vehicle that has a plurality of lift sources that generate lifting forces as in a case of a multi-rotor helicopter, a tilt-rotor machine or the like and is able to hover in the air by adjusting the plurality of the lift sources, and is characterized in that it allows the flight vehicle to be operated without requiring special training to operate the flight vehicle.

The control method for a flight vehicle of the present invention can be adopted for any flight vehicle as long as it is as described above. However, in particular, when the control method is adopted as a control method of a conveyance device that conveys an object in a state of hovering in the air, the conveyance device can be easily operated and the object can be simply conveyed. In the following, a case is described where the control method for a flight vehicle of the present invention is applied to a conveyance device that conveys an object.

### (Conveyance Device)

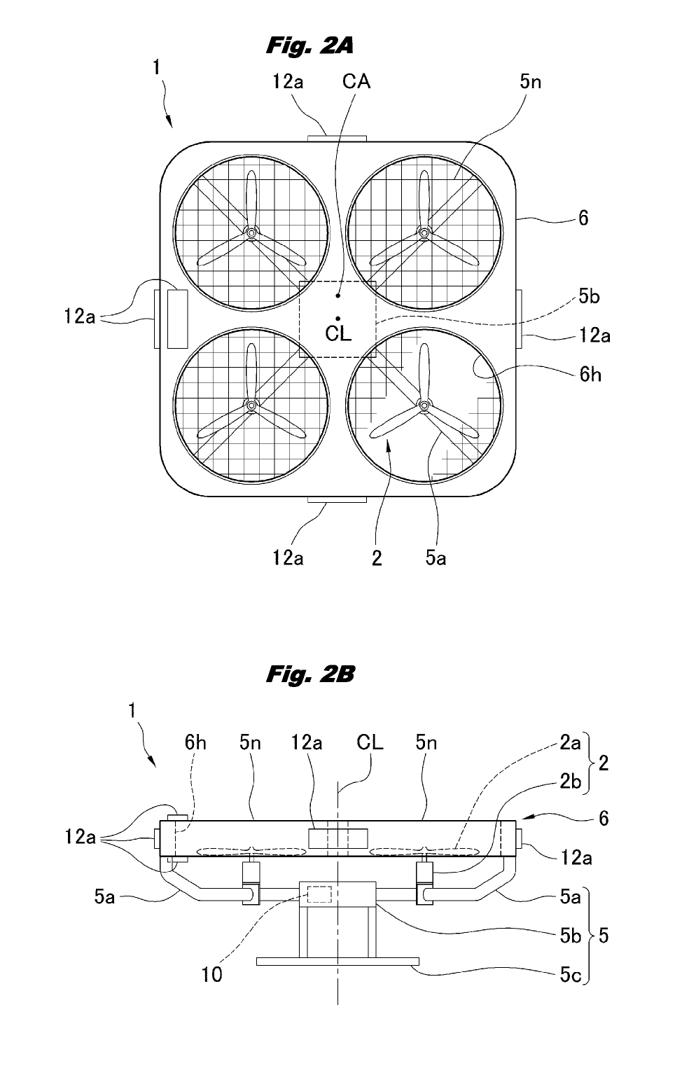

First, before describing the control method for a flight vehicle of the present invention, a conveyance device 1 is described. As illustrated in FIGS. 2A and 2B, the conveyance device 1 of the present embodiment includes four lift sources 2, a frame body 5, a cover frame 6, and a control part 10.

First, the frame body 5 includes a main body part 5b positioned at a center of the frame body 5. The main body part 5b accommodates therein the control part 10, a power source unit and the like. A leg part 5c for putting the conveyance device 1 on a ground surface or the like is provided on a lower end of the main body part 5b.

Base ends of four beams 5a are connected to the frame body 5. The four beams 5a are radially arranged in a plan view around the main body part 5b. That is, the four beams 5a are arranged in a manner extending outward from the main body part 5b.

Further, the four beams 5a are formed in a state in which front end parts thereof bend upward. The cover frame 6 is supported by the front ends of the four beams 5a. Specifically, the four beams 5a are provided in a manner that the front end parts thereof are inclined with respect to an upper surface of the cover frame 6.

The cover frame 6 is formed in a substantially square shape in a plan view. The front ends of the four beams 5a are respectively connected to vertex portions of the cover frame 6. The cover frame 6 is arranged such that a center of the cover frame 6 is positioned on a central axis CL of the frame body 5. When the central axis CL of the frame body 5 and a central axis of the cover frame 6 are provided to match each as described above, the central axis CL of the frame body 5 matches a central axis CL of the conveyance device 1.

Four rotor accommodating parts 6h that penetrate through upper and lower surfaces of the cover frame 6 are provided in the cover frame 6. The four rotor accommodating parts 6h are provided to be rotationally symmetrical around the central axis CL of the frame body 5 at equal angular intervals. Specifically, the four rotor accommodating parts 6h are formed around the central axis CL of the frame body 5 at 45-degree intervals.

On the upper surface of the cover frame 6, a portion surrounded by the four rotor accommodating parts 6h forms a mounting part CA for mounting an object to be conveyed by the conveyance device 1 of the present embodiment. The mounting part CA corresponds to a holding part of the claims.

Further, it is also possible that a table or the like is provided at a position above and separated from the upper surface of the cover frame 6 and the table or the like is used as the mounting part CA. When such a table or the like is provided, there is an advantage that a size of the mounting part CA can be freely set.

Further, when the table or the like as the mounting part CA is provided separately from the cover frame 6, a mechanism that maintains the table or the like constantly horizontal may be provided in the cover frame 6 or in the frame body 5. For such a mechanism (horizontal level maintaining mechanism) that maintains the table or the like constantly horizontal, a commonly known mechanism can be adopted. For example, a gimbal mechanism can be adopted as the horizontal level maintaining mechanism. When such a horizontal level maintaining mechanism is adopted, the plate-shaped table or the like is supported by the horizontal level maintaining mechanism, and is arranged in such a manner that, in a state in which the conveyance device 1 is horizontally arranged, an upper surface of the plate-shaped table or the like is parallel to or substantially flush with the upper surface of the cover frame 6. Then, as will be described later, even when the conveyance device 1 is in a state inclined relative to a horizontal level, the table or the like can be maintained horizontal. Therefore, during conveyance, the object that is conveyed can be held in a stable state. Of course, it is also possible that the table or the like is supported by the horizontal level maintaining mechanism in a manner that the table or the like is positioned on the upper surface of the cover frame 6.

Further, net-like protective members 5n are provided on upper openings of the rotor accommodating parts 6h. The protective members 5n are provided for preventing an object from entering into the rotor accommodating parts 6h from the upper surface of the cover frame 6.

As illustrated in FIGS. 2A and 2B, rotary wings 2a of the four lift sources 2 are respectively accommodated in the four rotor accommodating parts 6h. A main shaft of a drive source 2b such as a motor that rotates the rotary wings 2a is connected to the rotary wings 2a of each of the lift sources 2. The drive sources 2b are respectively secured on the four beams 5a.

Specifically, the four lift sources 2 are provided in such a manner that the main shafts of the drive sources 2b are parallel to the central axis CL of the frame body 5 and are rotationally symmetrical around the central axis CL of the frame body 5 at 45-degree intervals. The four lift sources 2 are arranged in such a manner that the main shafts of the drive sources 2b of the lift sources 2 respectively pass through centers of the rotor accommodating parts 6h that accommodate the rotary wings 2a.

The control part 10, the power source unit and the like that are accommodated in the main body part 5b are electrically connected to the drive sources 2b of the four lift sources 2. The four lift sources 2 are driven by power supplied from the power source unit based on a command from the control part 10.

The control part 10 controls actuation of the four lift sources 2 as follows. Usually, the conveyance device 1 is put in a state in which the conveyance device 1 hovers in the air (that is, in a hovering state). In the hovering state, when an input is received from outside, the conveyance device 1 is moved in response to the input and is again put in a hovering state. Details will be described later. To activate the conveyance device 1, an activation signal is transmitted to the control part 10 using a switch, a remote control or the like. Thereby, according to an activation sequence that was previously stored in a memory 13, the conveyance device 1 is adjusted so as to be in an initial hovering state at a predetermined height.

Since the conveyance device 1 is configured as described above, when an object to be conveyed is mounted on the mounting part CA of the conveyance device 1 of the present embodiment placed on the ground and the conveyance device 1 is activated, the four lift sources 2 are actuated and the conveyance device 1 is put in a hovering state at a predetermined height. In this state, when there is an input to the conveyance device 1 from outside (or external) of the conveyance device 1, in response to the input, the conveyance device 1 moves and, when having moved a distance in accordance with the input, the conveyance device 1 is again in a hovering state. To land the conveyance device 1, a stop signal is transmitted to the control part 10 using a switch, a remote control or the like. Thereby, according to a landing sequence that is stored in advance in the memory 13, the conveyance device 1 can be landed on the ground. That is, the object can be conveyed from a position where the conveyance device 1 is initially placed to a landing site. In addition, the object can be conveyed by being placed on the upper surface of the conveyance device 1. Therefore, it is not required to hang the object to be conveyed as in a case of a common radio control helicopter or the like, and the conveyance of the object becomes easy.

Further, it is also possible to place an object to be conveyed on the mounting part CA of the conveyance device 1 in a hovering state. Then, when an object placed at a position away from the ground is conveyed, by adjusting the height of the mounting part CA of the conveyance device 1 to match the height of the object, the object can be simply placed on the mounting part CA. In addition, even when a place (destination) where the object is to be moved to is away from the ground, by adjusting the height of the mounting part CA of the conveyance device 1 to match the height of the destination, the object on the mounting part CA can be simply moved to the destination. Then, when moving an object in a position away from the ground or moving an object to a position away from the ground, there is no need to raise or lower the object in order to load or unload the object to or from the mounting part CA of the conveyance device 1. Therefore, the object can be very easily moved.

When power of the conveyance device 1 is used up during operation, the conveyance device 1 crashes, which is dangerous. Therefore, when the amount of power of the power source is below a certain amount, the conveyance device 1 may be landed on the ground according to a charging request sequence that is stored in advance in the memory 13.

Further, in the charging request sequence, the conveyance device 1 may be vertically lowered from a position at which execution of the charging request sequence starts. However, when the charging request sequence is executed when the conveyance device 1 is above a river or the like, it is possible that the conveyance device 1 is sunk into the river or the like, and it is possible that the conveyance device 1 is damaged or cannot be recovered. Therefore, a position at which the conveyance device 1 is to be landed when the charging request sequence is executed may be stored in advance in the memory 13.

Further, when the conveyance device 1 has moved to a position at which an operation such as touching by an operator cannot be performed due to a cause such as that a force applied to the conveyance device 1 is too large, it is possible that the conveyance device 1 cannot be recovered until the power is used up. For example, when the conveyance device 1 is stopped above a river or is stopped at a height half way between floors during an operation at a high place, the operator cannot operate the conveyance device 1. In the case where the charging request sequence is not stored in the memory 13, when the power is used up, the conveyance device 1 crashes. Therefore, it is also possible that, when there has been no input over a certain period of time in the memory 13, a no-input sequence that is stored in advance in the memory 13 is executed to return the conveyance device 1 to coordinates where the conveyance device 1 previously stopped (hovered). Of course, it is also possible that the position, to which the conveyance device 1 returns while the no-input sequence is executed, is arbitrarily stored in the memory 13 or is set by operating a remote control or the like.

### (About Lift Sources 2)

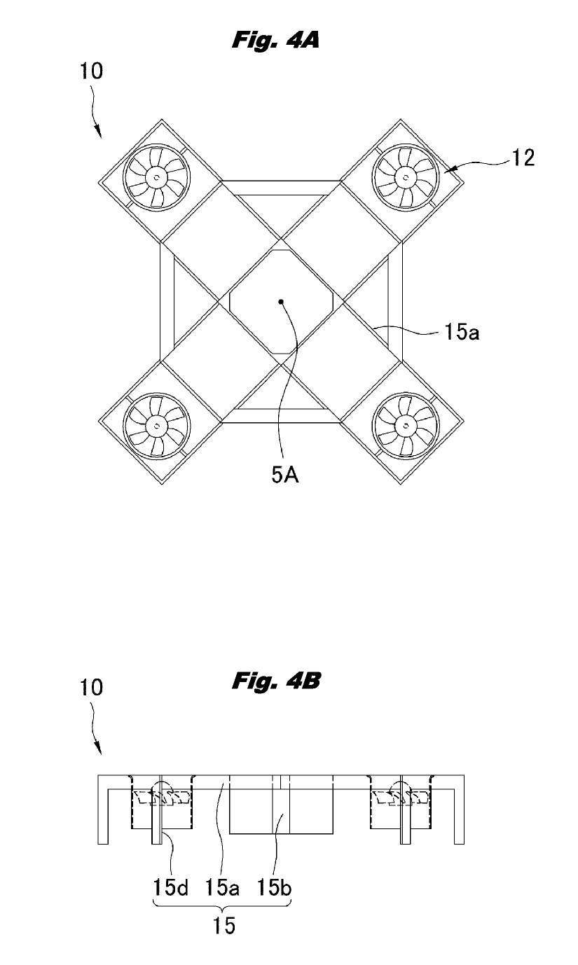

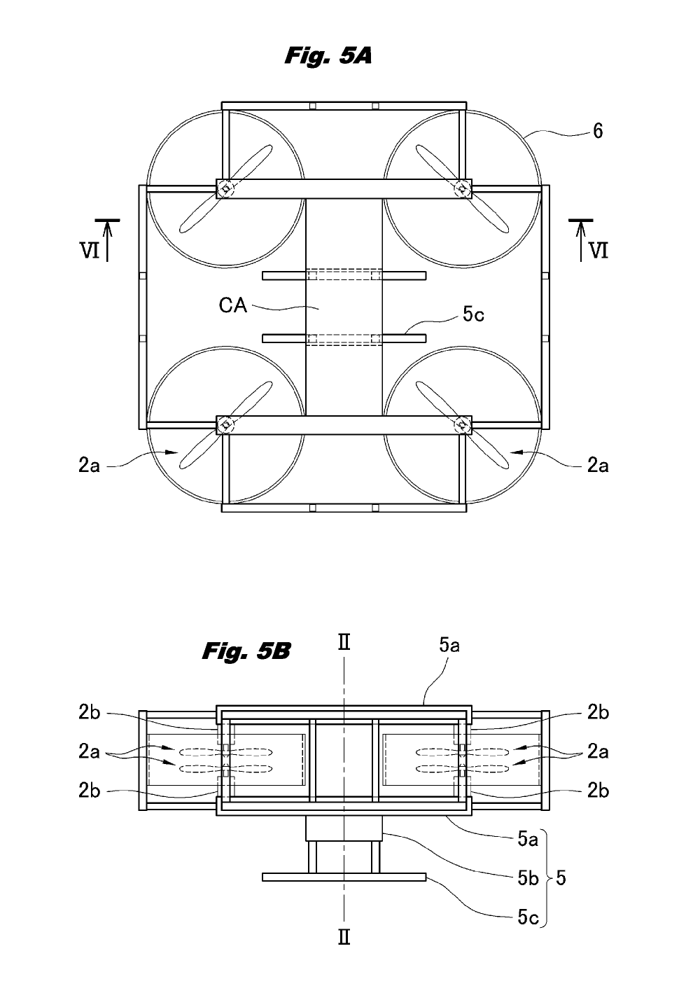

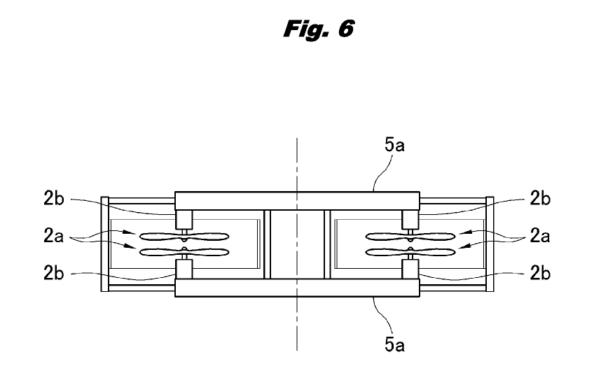

The number of the lift sources 2 that are provided is not particularly limited, and may be three, or five or more. Further, in the above, an example is described in which the lift source 2 is adopted that generates a lift force by rotating the rotary wings 2a. However, any lift source 2 that can generate a lift force may be adopted. For example, as illustrated in FIGS. 4A and 4B, a duct fan can be adopted in place of the rotary wings 2a. Further, a counter-rotating propeller that includes two rotary wings 2a can also be adopted (see FIGS. 5A, 5B and 6). When the counter-rotating propeller is adopted, a thrust force can be increased without increasing an area of a rotating surface of the propeller. Then, an advantage can be obtained that a heavy load can be carried without increasing a body size of the conveyance device 1 or reducing a surface area of the mounting part CA.

### (About Cover Frame 6)

The cover frame 6 is not particularly limited in its structure, shape and material as long as it can support a weight of an object when the objected is placed on the conveyance device 1 while reducing a weight of the conveyance device 1. In the above example, a case is described where the cover frame is substantially square in plan view. However, for example, the cover frame may also have a regular hexagonal shape when six lift sources 2 are provided, may also have a regular octagonal shape when eight lift sources 2 are provided, and of course may also have a circular shape.

Further, in the above example, the cover frame 6 is provided and the rotary wings 2a are provided in the rotor accommodating parts 6h of the cover frame 6. However, it is not necessarily required to provide the cover frame 6. However, when the above configuration is adopted, there is no risk that the rotary wings 2a are in contact with other objects so that the rotary wings 2a are damaged or other objects are damaged by the rotary wings 2a, and thus the above configuration is preferred.

On the other hand, when there is a casing around the rotary wings as in the case of using a duct fan or the like as the lift source 2, the casing can have the function of the cover frame as described above, and thus it is possible that the cover frame is not provided (see FIGS. 4A and 4B).

When the cover frame 6 is not provided, an upper surface of the main body part 5b can be used as the mounting part CA, or, when pillars are erected on the main body part 5b and a table is provided on upper ends of the pillars, an upper surface of the table can be used as the mounting part CA.

### (About Frame Body 5)

The frame body 5 is also not particularly limited in its structure, shape and material as long as it can support a weight of an object when the objected is placed on the conveyance device 1 while reducing the weight of the conveyance device 1. For example, as in a conveyance device 10 of FIGS. 4A and 4B, a frame body 15 may be formed by combining plates. Specifically, the frame body 15 has a support frame 15a that is formed by combining the plates in a double-cross shape, and has a main body part 15b that is arranged at a center of the support frame 15a. Lift sources 12 may be respectively provided at front ends of the support frame 15a. In FIGS. 4A and 4B, a reference numeral symbol 15d indicates a leg part for putting the conveyance device 10 on a ground surface or the like.

Further, in a conveyance device 10 of FIGS. 4A and 4B, duct fans are used as the lift sources 12 and a cover frame is not provided. Therefore, an upper surface of the main body part 15b may be used as the mounting part CA. Of course, when pillars are erected on the support frame 15a and a table is provided on upper ends of the pillars, an upper surface of the table can be used as the mounting part CA.

### (Description of Control Method)

Next, a control method is described that allows the above-described operations with respect to the conveyance device 1 of the present embodiment.

The control part 10 has a stationary control function that controls the actuation of the four lift sources 2 so as to maintain a hovering state, a moving control function that controls the actuation of the four lift sources 2 when the conveyance device 1 moves, and a switching function that switches between the two functions.

### (Description of Sensors)

Here, the control part 10 has a plurality of sensors 10a in order to maintain a hovering state, and a controller 11 that calculates a posture and an operation of the conveyance device 1 based on signals from the plurality of sensors 10a.

The sensors 10a that the control part 10 has, for example, include an acceleration sensor, a gyro sensor, an ultrasound sensor, an optical flow sensor, a GPS, a geomagnetism sensor, and the like. As such sensors, commonly known sensors such as commercially available sensors can be adopted. By providing the sensors, the following situations can be grasped. The following description merely illustrates states detected by the sensors and states that can be grasped based on the states detected by the sensors. The present invention is not limited by the following description.

The acceleration sensor can detect an acceleration of the conveyance device 1. Therefore, based on the acceleration, the controller 11 can calculate a movement speed of the conveyance device 1 and an external force applied to the conveyance device 1.

When the gyro sensor is provided, an angular speed due to the movement of the conveyance device 1 can be detected. Therefore, based on the angular speed, the controller 11 can detect an inclination of the conveyance device 1 (that is, an inclination with respect to a horizontal level).

The ultrasound sensor can detect a distance between the conveyance device 1 and the ground surface or the like. Therefore, the controller 11 can detect a height of the conveyance device 1 and whether or not the conveyance device 1 is in a floating state. Instead of the ultrasound sensor, it is also possible to provide a laser distance meter to measure the distance between the conveyance device 1 and the ground surface or the like.

Based on a signal from the geomagnetism sensor, which direction the conveyance device 1 is oriented in can be detected.

The optical flow sensor can detect a situation around the conveyance device 1. Therefore, based on information from the optical flow sensor, the controller 11 can detect positional displacement or the like of the conveyance device 1 with respect to a reference position.

The GPS can detect a position of the conveyance device 1. Therefore, based on information from the GPS, the controller 11 can grasp the position of the conveyance device 1.

When the conveyance device 1 is used outdoor (that is, in a place where signals from a GPS satellite can be stably received), the GPS is preferably used for the position detection of the conveyance device 1. When the conveyance device 1 is used indoor (that is, in a place where signals from a GPS satellite is unstable), the optical flow sensor is preferably used for the position detection of the conveyance device 1.

### (Stationary Control Function)

The stationary control function is described. As described above, the stationary control function is a function that controls the actuation of the four lift sources 2 so as to maintain a hovering state. Specifically, the stationary control function is a function that puts the conveyance device 1 in a hovering state at a predetermined height and a predetermined position in a state in which an external force is not input to the conveyance device 1, and has a normal hovering maintaining function and an initial hovering state maintaining function.

### (Initial Hovering State Maintaining Function)

The initial hovering state maintaining function is a function that controls the actuation of the four lift sources 2 so that the conveyance device 1 is in a hovering state (hereinafter, referred to as an initial hovering state) at a predetermined height and a predetermined position when the conveyance device 1 of the present embodiment is actuated. For example, when the conveyance device 1 is placed on the ground surface or the like and the conveyance device 1 is activated, initial hovering state maintaining function means a function that puts the conveyance device 1 in a hovering state at a predetermined height vertically above the ground surface or the like (for example, a height of about 1 m).

In the initial hovering state, the height and the position at which the conveyance device 1 is in the hovering state are not particularly limited, and may be determined based on a height and a position of the conveyance device 1 when the conveyance device 1 is activated. For example, the conveyance device 1 can be put in a hovering state vertically above the ground surface or the like where the conveyance device 1 and at a predetermined distance from the ground surface or the like. Further, the memory 13 is provided in the control part 10 and information about the initial hovering state (initial hovering state information) may be stored in the memory 13. In particular, when the memory 13 is provided, by allowing the initial hovering state information to be suitably modified, the conveyance device 1 can be put in a suitable initial hovering state according to a condition in which the conveyance device 1 is used.

### (Normal Hovering Maintaining Function)

The normal hovering maintaining function is a function that puts the conveyance device 1 in a hovering state after the conveyance device 1 is moved to a predetermined position under the control of the moving control function (to be described later). The normal hovering maintaining function has a function similar to the initial hovering function by which the conveyance device 1 maintains a hovering state at the height and the position of the conveyance device 1 when an external force has not been applied to the conveyance device 1. However, the normal hovering maintaining function has a function different from the initial hovering function in that the hovering state is maintained at a predetermined position after the conveyance device 1 is moved to the predetermined position.

Specifically, in the normal hovering maintaining function, the position and height of the conveyance device 1, which has moved to a predetermined position and stopped moving, are stored as temporary hovering state information in the memory 13, and the hovering state of the conveyance device 1 is maintained based on the temporary hovering state information. The temporary hovering state information may be canceled when the conveyance device 1 starts to move, or may be rewritten when the conveyance device 1 moves to a predetermined position and stops moving.

Further, the temporary hovering state information may be all stored in time order. In this case, the way how the conveyance device 1 was moved can be grasped later. Further, when the normal hovering maintaining function is actuated by reading out from the memory 13 the temporary hovering state information stored in the memory 13, the conveyance device 1 can be returned from a movement destination to the original position.

In the hovering state, when a new weight of an object to be conveyed is applied by loading the object on the mounting part CA, the height of the conveyance device 1 is to be reduced if the lifting force generated by the four lift sources 2 does not change. Therefore, the initial hovering state maintaining function and the stationary control function change the lifting force generated by the four lift sources 2 so that the predetermined height is maintained when the new object is loaded. That is, the initial hovering state maintaining function and the stationary control function perform the height control that maintains the conveyance device 1 at the predetermined height.

Further, in the state in which the object is not loaded, the four lift sources 2 are controlled to generate substantially the same lifting forces. However, when the object is loaded on the mounting part CA, it is needless to say that, depending on a position of a gravity center of the object, in order to maintain a hovering state, the lifting forces generated by the four lift sources 2 are adjusted to in a state in which the lifting forces are different from each other.

Further, a pressure sensor may be attached to the mounting part CA. In this case, due to the pressure sensor, the weight of the object that is conveyed can be measured. Therefore, information about the weight of the object can be used in adjusting parameters of height control and posture control. Then, lifting force insufficiency caused by weight increase due to the loading of the object to be conveyed can be quickly resolved. Therefore, when the object to be conveyed is loaded or unloaded, vertical movement and posture changing of the conveyance device 1 can be suppressed.

### (About Control Method)

In the above-described initial hovering state maintaining function and stationary control function, the control method for maintaining the hovering state is not particularly limited. A commonly known control method can be adopted. For example, PID control, state feedback, H∞ control, classical control, modern control, optimal control, adaptive control, fuzzy control or the like can be adopted. However, when the hovering state is maintained by the PID control based on signals from the sensors 10a, an advantage can be obtained that the control becomes easy and stability during hovering is improved.

When the hovering state is maintained by the commonly know control such as the PID control, the state feedback, the H∞ control, the classical control, the modern control, the optimal control, the adaptive control and the fuzzy control, among the above-described sensors, at least the acceleration sensor, the gyro sensor, the geomagnetism sensor and the ultrasound sensor (or the laser distance meter) can be used, and further, it is preferable to have the optical flow sensor and the GPS.
1) Regarding the PID control, the following is incorporated herein by reference:

Y Mori, “ENSYU DE MANABU PID SEIGYO (Lessons of PID Control by Exercise)” Morikita Publishing Co., Ltd., ISBN-13: 978-4627920514.

Japanese Patent No. 4961166.
2) Regarding the state feedback control, the following is incorporated herein by reference:

Japanese Patent No. 4644562.
3) Regarding the H∞ control, the following is incorporated herein by reference:

H Kimura, “H∞ SEIGYO (H Infinity Control)” Corona Publishing Co., Ltd. ISBN-13: 978-4339030983.
4) Regarding the adaptive control, the following is incorporated herein by reference:

K Hirai, “HISENKEI SEIGYO (Non-Linear Control)” Corona Publishing Co., Ltd., ISBN: 978-4-339-02608-5.
5) Regarding the fuzzy control, the following is incorporated herein by reference:

M Sugano, “FUZZY SEIGYO (Fuzzy Control)” Nikkan Kogyo Shimbun, Ltd, ISBN-13: 978-4526023484.

### (Moving Control Function)

The moving control function is described. The moving control function is a function that moves the conveyance device 1 in response to an input external force when the external force is input to the conveyance device 1 that has been put in a hovering state by the stationary control function.

In order to realize the moving control function, the control part 10 includes an input part 12 that detects an external force input to the conveyance device 1. The input part 12 includes: a sensor that has a function that detects touching by a human or the like and a magnitude of a force due to the touching; a sensor that detects input of an external force based on a change in the posture or position of the conveyance device 1; a touch panel; and the like.

Touching on the conveyance device 1 by a human or the like in general corresponds to a direct input described in the claims. For example, applying a force to the conveyance device 1 by touching the conveyance device 1 by a human or the like or by pulling the conveyance device 1 by attaching a rope or the like to the conveyance device 1 corresponds to an input of an external force in the present invention. Further, lightly touching on the conveyance device 1 by a human or the like, or touching by a human or the like on the input part 12 as a touch panel, is not an input of an external force, but is included in the direct input in the present invention.

### (Input Detection by Contact Sensor)

As the sensor having the function that detects touching by a human or the like and a magnitude of a force due to the touching, for example, a commonly known pressure sensor or the like can be used.

Sensors 12a of the input part 12 are provided such that they can be touched even when the conveyance device 1 is in a hovering state. For example, the input part 12 is provided on a surface of the cover frame 6.

In addition, the input part 12 is provided such that a direction in which a force is applied can be grasped. For example, for the cover frame 6 as illustrated in FIGS. 2A and 2B, it is preferable that the sensors 12a of the input part 12 be provided on four side surfaces of the cover frame 6 and on the upper and lower surfaces of the cover frame 6. Then, depending on which sensors 12a are touched or not touched, the control part 10 can grasp a direction in which a force is applied. FIGS. 2A and 2B illustrate an example in which the sensors 12a are provided on portions of the four side surfaces and upper and lower surfaces of the cover frame 6. However, it is also possible that the sensors are provided over the entire surfaces of the four side surfaces and upper and lower surfaces of the cover frame 6. In this case, a position where the cover frame 6 is touched by a human in order to operate the conveyance device 1 is not limited. Therefore, the conveyance device 1 is easy to operate. Further, depending on a touch position, fine movement of the conveyance device 1 can be controlled.

### (Input Detection by Posture Change)

Further, it is also possible to grasp an input of an external force to the conveyance device 1 based on a posture change of the conveyance device 1 in a hovering state. In this case, the above-described sensors 10a such as the gyro sensor that are required for maintaining a hovering state can be used as sensors of the input part 12.

For example, in a hovering state, the conveyance device 1 of FIGS. 2A and 2B is maintained such that the posture of the conveyance device 1 is horizontally oriented (in other words, the central axis CL of the frame body 5 is vertically oriented). It is possible that, when the posture is inclined more than a certain degree from this state, based on a signal of the gyro sensor or the like, it is determined that an external force is input. Further, it is also possible that, when the conveyance device 1 has been moved from a predetermined position a certain distance or more in a horizontal direction or in a vertical direction, based on a signal of the ultrasound sensor (or the laser distance meter), the optical flow sensor, or the like, it is determined that an external force is input.

### (About Control Method)

In the above-described moving control function, the control method that controls the movement of the conveyance device 1 is not particularly limited, and can adopt a commonly known control method. For example, commonly known control methods such as the PID control, the state feedback, the H∞ control, the classical control, the modern control, the optimal control, the adaptive control and the fuzzy control can be adopted. However, when the movement is controlled by performing PD control based on a signal from the above-described sensors, the control becomes easy. In particular, an advantage is obtained that, when an external force is input so that the conveyance device 1 is inclined, by maintaining the posture of the conveyance device 1 at an inclination angle at which the external force and an operating force of the posture control balance each other, a movement force that is generated in the conveyance device 1 is automatically determined. In the case where the optical flow sensor or the GPS is included, in the moving control function, when position control based on information from such a sensor is stopped, movement of the conveyance device 1 becomes smooth.

Regarding the PD control, the following is incorporated herein by reference:
Japanese Patent No. 4961166.

### (About Safety Function)

Here, when the input detection based on a posture change is adopted, in a hovering state, when a strong wind or the like blows or when a human or the like accidentally touches the conveyance device 1, there is a possibility that the control part 10 erroneously determines that a force is input to change the posture of the conveyance device 1 or to move the conveyance device 1. In order to prevent such a problem, it is preferable to provide an initiation sensor that an operator operates when the conveyance device 1 is moved. For example, a contact sensor that an operator touches before moving the conveyance device 1, a tactile switch or the like can be adopted as the initiation sensor.

Of course, as described above, when the conveyance device 1 is actuated by detecting a force with which the operator touches the conveyance device 1 and a direction of the force, the above-described input detection part can function as the initiation sensor. For example, when an input is equal to or less than a certain input and a contact time is equal to or longer than a certain time period, the input detection part transmits an initiation start signal. Thereby, the input detection part can function as an initiation sensor.

A method for determining a posture change input is not limited to the above method. For example, it is also possible that, when the input detection part is touched twice (that is, tapped twice) during a short time period, the input detection part transmits an initiation start signal.

### (Description of Operations to Move Conveyance Device 1)

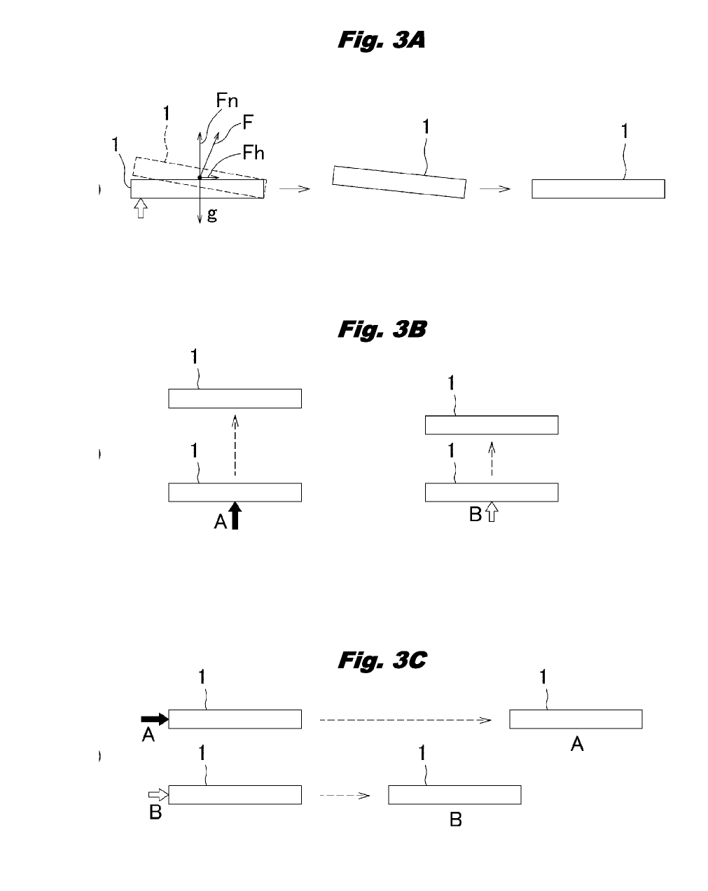

Based on FIGS. 3A-3C, examples of operations to move the conveyance device 1 are described.

First, a case illustrated in FIG. 3A is described. FIG. 3A illustrates an example in which the PID control is adopted in the stationary control function, and the PD control is adopted in the moving control function. The example illustrated in FIG. 3A in the following is a case where the conveyance device 1 is substantially horizontally moved. Therefore, in the moving control function of the example illustrated in FIG. 3A, control (height control) is performed based on a signal from the ultrasound sensor, the laser distance meter or the like so that the height of the conveyance device 1 during movement of the conveyance device 1 is substantially the same as a height of a hovering state. For the height control, for example, the commonly known control methods such as the PID control, the state feedback, the H∞ control, the classical control, the modern control, the optimal control, the adaptive control and the fuzzy control can be adopted.

FIG. 3A illustrates a case where one edge of the conveyance device 1 is raised so that the conveyance device 1 in a hovering state is inclined. That is, FIG. 3A illustrates a case where a force is applied to one edge of the conveyance device 1 so that the conveyance device 1 is inclined.

In this case, when the conveyance device 1 is in an inclined state in which the conveyance device 1 is inclined, the gyro sensor of the control part 10 detects the inclination. When the inclination detected by the gyro sensor is equal to or larger than a predetermined value, the control by the controller 11 is switched from one control by the stationary control function to the other control by the moving control function.

Then, the controller 11 controls actuation of the four lift sources 2 so that the conveyance device 1 in an inclined state is in a stable state. Specifically, in the state of FIG. 3A, the four lift sources 2 actuate such that the conveyance device 1 is in a state in which a vertical component Fn of a lifting force F generated by the four lift sources 2 is balanced by the gravity g. In this state, a horizontal component Fh of the lifting force F is generated. Therefore, a force is generated that moves the conveyance device 1 in the horizontal direction.

In this state, when a hand is released from the one edge of the conveyance device 1, the conveyance device 1 continues to move in the horizontal direction and changes its posture due to the gravity so that the posture is in a horizontal state. When the conveyance device 1 is in a horizontal state, the force that horizontally moves the conveyance device 1 no longer exists. However, the conveyance device 1 moves due to the horizontal component force Fh generated during the transition from the inclined state to the horizontal state, and moves, due to inertia, to and stops at a position where the conveyance device 1 can no longer move in the horizontal direction due to air resistance and the like.

When the movement of the conveyance device 1 stops, the control by the controller 11 switches from the moving control function to the stationary control function.

As described above, by simply applying a force to incline the conveyance device 1 in a hovering state, the conveyance device 1 can be moved in the horizontal direction. In addition, a movement distance can be adjusted by simply changing the time of the transition from the inclined state to the horizontal state, that is, by changing an angle at which the conveyance device 1 is inclined. Therefore, the conveyance device 1 can be easily operated, and can be easily operated by anyone without having to do particular practice or having to become familiar with the operation.

Further, FIGS. 3B and 3C illustrate other operation methods. FIGS. 3B and 3C illustrate examples in which the stationary control function and the moving control function both adopt the PID control.

FIG. 3B illustrates a case where a human operates the conveyance device 1 by touching a contact sensor of the bottom surface of the conveyance device 1. As illustrated in FIG. 3B, when a human applies an upward force to the conveyance device 1, when a force detected by the contact sensor is equal to or larger than a predetermined value, the control by the controller 11 switches from the control by the stationary control function to the control by the moving control function.

Then, the controller 11 calculates a distance (target movement distance or target movement time) over which the conveyance device 1 is moved in correspondence to the force detected by the contact sensor, and controls the actuation of the four lift sources 2 so that the conveyance device 1 is moved upward for the target movement distance (or target movement time) only. For example, when the lifting forces generated by the four lift sources 2 are the same in the hovering state, the four lift sources 2 are controlled so that the lifting forces generated by the lift sources 2 are the same and are similarly increased in correspondence to the applied force. Then, the conveyance device 1 rises for the target movement distance only (or for a time period of the target movement time only). In the case of FIG. 3B, the conveyance device 1 rises to a higher position when pushed by a strong force than when pushed by a weak force B.

When the controller 11 detects that the conveyance device 1 has risen to a predetermined height based on information of the ultrasound sensor or the like, the control by the controller 11 switches from the moving control function to the stationary control function, and the conveyance device 1 is in a hovering state.

FIG. 3C illustrates a case where a human operates the conveyance device 1 by touching a contact sensor of a side surface of the conveyance device 1. As illustrated in FIG. 3C, when a human applies a horizontal force to the conveyance device 1, when a force detected by the contact sensor is equal to or larger than a predetermined value, the control by the controller 11 switches from the control by the stationary control function to the control by the moving control function.

Then, the controller 11 controls the actuation of the four lift sources 2 to horizontally move the conveyance device 1 for only a distance (target movement distance or target movement time) in correspondence to a force detected by the contact sensor. Specifically, a relation between the lifting forces generated by the four lift sources 2 is controlled so that the conveyance device 1 is inclined. Specifically, the relation between the lifting forces generated by the lift sources 2 is controlled so that the conveyance device 1 is inclined at an inclination angle that is required in order to generate a force to move the conveyance device 1 over the target movement distance. Then, the conveyance device 1 moves in the horizontal direction over only a distance corresponding to the inclination of the conveyance device 1, that is, the target movement distance. For example, when the conveyance device 1 is pushed by a strong force A, the inclination of the conveyance device 1 is large and the movement distance (in other words, the movement time) of the conveyance device 1 in the horizontal direction is long. When the conveyance device 1 is pushed by a weak force B, the inclination of the conveyance device 1 is small and the movement distance (in other words, the movement time) of the conveyance device 1 in the horizontal direction is short.

When the controller 11 detects that the conveyance device 1 has moved the target movement distance (or the target movement time) based on information of the GPS or the like, the control by the controller 11 switches from the moving control function to the stationary control function, and the conveyance device 1 is in a hovering state.

As described above, by simply touching the conveyance device 1 in a hovering state so as to apply a force to the conveyance device 1, the conveyance device 1 can be moved. In addition, the movement distance can be adjusted by changing a force applied to the conveyance device 1 (for example, a force pushing the conveyance device 1). Therefore, the conveyance device 1 can be easily operate, and can be easily operated by anyone without having to do particular practice or having to become familiar with the operation.

It is also possible that the movement distance is controlled not only according to a force applied to the conveyance device 1, but also according to a time period during which the force is applied or a time period during which the conveyance device 1 is touched. In the case where a positioning sensor such as the GPS can be used as in the case of outdoor, it is also possible that the controller 11 calculates a target place in correspondence to the input of the conveyance device 1 and controls the four lift sources 2 so that the conveyance device 1 stops at the target place. Further, in the case where a positioning sensor such as the GPS cannot be used as in the case of indoor, or in the case where the conveyance device 1 does not have a positioning sensor such as the GPS, it is also possible that the conveyance device 1 moves based on conditions that are set in advance in correspondence to the input of the conveyance device 1. For example, it is also possible that the controller 11 calculates a movement distance and a movement direction based on the input of the conveyance device 1 and an operation amount that is set in advance, and controls the four lift sources 2 based on the calculated values.

### (Description of Other Operations to Move Conveyance Device 1)

Further, in the above example, a case is described where the conveyance device 1 is controlled in such a manner that, when an operator touches the conveyance device 1 in a hovering state so as to apply a force to the conveyance device 1, regardless of a position of the operator, the conveyance device 1 moves over a distance (or time) corresponding to the input force. On the other hand, it is also possible that the conveyance device 1 is controlled in such a manner that, when the operator applies a force to the conveyance device 1, the conveyance device 1 moves while maintaining a state of being in contact with the operator. In this case, both the stationary control function and the moving control function adopt the PID control.

For example, when an operator pushes the conveyance device 1 in a hovering state by applying a force to it, the four lift sources 2 are controlled in such a manner that the conveyance device 1 moves with a speed that is substantially the same as a speed with which the conveyance device 1 is pushed. In other words, the four lift sources 2 are controlled in such a manner that the conveyance device 1 moves while maintaining a state in which the operator is in contact with the conveyance device 1. For example, the relation between the lifting forces generated by the four lift sources 2 is controlled so that a movement force is generated accompanying the inclination of the conveyance device 1. Then, the operator can move the conveyance device 1 in the same feeling as moving a dolly on the ground by pushing the dolly. In order to realize such movement of the conveyance device 1, in the moving control function, the movement of the control conveyance device 1 may be controlled such that the force applied to the conveyance device 1 is constant.

In the following, in the case where the above-described control is realized, the operation of the conveyance device 1 and the control thereof are described.

First, the control is composed to be switched from the stationary control function to the moving control function when a force (command input force) of a certain degree or larger is applied to the conveyance device 1. In other words, until the command input force is applied to the conveyance device 1, the stationary control function is maintained. Then, when an operator pushes the conveyance device 1 in order to move the conveyance device 1 in a hovering state, until the pushing force becomes the command input force, the conveyance device 1 tends to maintain a position of the hovering state.

When the force with which the operator pushes the conveyance device 1 becomes equal to or larger than the command input force, the control switches from the stationary control function to the moving control function. In the moving control function, the movement of the conveyance device 1 is controlled such that the force applied to the conveyance device 1 becomes smaller than the command input force. That is, in the moving control function, when a force equal to or larger than the command input force is applied, the actuation of the four lift sources 2 is controlled such that the conveyance device 1 moves in a direction in which the force is applied to the conveyance device 1 until the force is smaller than the command input force.

When the force applied to the conveyance device 1 becomes smaller than the command input force due to the movement of the conveyance device 1 or due to that the operator weakens the force with which the operator pushes the conveyance device 1, the control switches from the moving control function to the stationary control function. Then, the actuation of the four lift sources 2 is controlled such that the conveyance device 1 is in a hovering state at a position at which the force applied to the conveyance device becomes smaller than the command input force.

When the force pushing the conveyance device 1 becomes equal to or larger than the command input force due to that the movement of the conveyance device 1 stops or due to that the operator strengthens the force which the operator pushes the conveyance device 1, the control switches from the stationary control function to the moving control function. Then, the actuation of the four lift sources 2 is controlled such that the conveyance device 1 moves in the direction in which the force is applied to the conveyance device 1 and the force pushing the conveyance device 1 becomes smaller than the command input force.

In the above-described state, that is, by repeating switching from the stationary control function to the moving control function and switching from the moving control function to the stationary control function, the conveyance device 1 can be moved while maintaining the state in which the operator is in contact with the conveyance device 1.

When the above-described control is performed, when the force pushing the conveyance device 1 fluctuates about the command input force, the moving control function and the stationary control function are frequently switched between each other. Then, there is a possibility that the movement of the conveyance device 1 is not smooth. Therefore, in order to smooth the movement of the conveyance device 1, it is preferable that a slight time lag be provided after the force applied to the conveyance device becomes smaller than the command input force and until the control is switched from the moving control function to the stationary control function.

Similar to the above-describe horizontal movement, when a force equal to or larger than a command input force pushing the conveyance device 1 upward or downward is input, the actuation of the four lift sources 2 is controlled such that the conveyance device 1 moves a distance proportional to the magnitude of the input force in a direction in which the pushing force is reduced. In this case, the height of the conveyance device 1 changes. Therefore, after the input force becomes equal to or larger than the command input force and until the input force becomes smaller than the command input force, the height control is stopped, and the conveyance device 1 is moved upward or downward. When the input force becomes smaller than the command input force, control is performed so that the conveyance device 1 is in a hovering state at the height of the conveyance device 1 at the time.

Of course, when a force equal to or larger than the command input force pushing the conveyance device 1 obliquely upward or obliquely downward, the actuation of the four lift sources 2 is controlled such that the conveyance device 1 moves obliquely upward or obliquely downward. For example, when the conveyance device 1 is pushed obliquely upward or obliquely downward, the conveyance device 1 can be moved along stairs or along a slope.

### (Orientation Change of Conveyance Device 1)

Further, when the force detected by the contact sensor is smaller than a predetermined value, it is also possible that the controller 11 controls the actuation of the four lift sources 2 such that the orientation of the conveyance device 1 is changed without changing the position of the conveyance device 1. That is, when the force applied to the conveyance device 1 is smaller than the above-described movement force but has a certain magnitude, it is also possible that the controller 11 determines that an input is performed to change the orientation of the conveyance device 1. A method for determining a posture change input is not particularly limited. For example, it is also possible that, when the input detection part is touched twice (that is, tapped twice) during a short time period, it is determined that an input to change the orientation of the conveyance device 1 is performed.

Further, in the above example, the case is described where the operator moves the conveyance device 1 by pushing it. However, even in a case where a pulling tool such as a string is connected to the conveyance device 1 and a force is applied to the conveyance device 1 by pulling the pulling tool, control similar to that in the above example can be performed. That is, it is also possible that the conveyance device 1 moves over a distance in correspondence to a force with which the pulling tool is pulled. In this case, the force applied to the conveyance device 1 is measured by providing a sensor such as a load cell between the pulling tool and the conveyance device 1. Then, the conveyance device 1 can be moved similar to the case where a dolly or the like is moved on the ground by pulling it. Specifically, when a force applied to the sensor by pulling the pulling tool becomes equal to or larger than a force of a certain value, the conveyance device 1 moves, and can maintain a hovering state when the pulling force is equal to or smaller than the certain value. Further, when a sensor (such as a triaxial load cell) that detects a direction in which a force is applied is provided between the pulling tool and the conveyance device 1 in addition to the sensor that detects the force, a direction in which the conveyance device 1 is moved can also be controlled by a direction in which the pulling tool is pulled. For example, in a case where a load cell is used as a sensor provided between the pulling tool and the conveyance device 1, when a triaxial load cell is used, the direction in which the pulling tool is pulled can be three-dimensionally grasped. Then, the conveyance device 1 can be moved not only horizontally and vertically, but also obliquely.

### (About Height Control)

As described above, in the stationary control function and the moving control function, the height control is performed such that the conveyance device 1 is positioned at a certain height. In this case, as described above, when the height control is performed by using the ultrasound sensor or the laser distance meter to measure a distance with respect to the ground surface (height above the ground), even when the ground surface below a movement path is sloped or is in a stair-like shape, the conveyance device 1 can be moved while maintaining a constant distance with respect to the slope or the stairs. That is, even when the ground surface below the movement path is sloped or is in a stair-like shape, the conveyance device 1 can be moved along the ground surface. Further, when there is an obstacle in the movement path, the conveyance device 1 can be moved to go over the obstacle.

On the other hand, when the height control is performed based on only the height above the ground, the height of the conveyance device 1 changes according to the situation of the ground surface below the conveyance device 1, and thus it is possible that the conveyance device 1 cannot be stably moved.

Further, in a case where a deep groove or the like is formed on the ground surface or in a case where the conveyance device 1 is moved along a floor surface or the like that is away from the ground surface such as a bridge provided on a road (hereinafter referred to as an aerial ground surface), when the conveyance device 1 is positioned above the groove or is moved in a place deviated from the aerial ground surface, the height of the conveyance device 1 rapidly changes. That is, when the conveyance device 1 is positioned above the groove, the height above the ground is measured relative to a bottom of the groove. Therefore, the conveyance device 1 moves to fall into the groove. Further, when the conveyance device 1 is positioned at a place deviated from above the aerial ground surface, the height above the ground is measured relative to the normal ground surface. Therefore, the conveyance device 1 falls to a predetermined height from the ground surface. Similar phenomena may occur depending on the situation of the ground surface when the conveyance device 1 is actuated and is put in a hovering state.

Therefore, it is also possible that the height control is performed based on not only the height above the ground, but also an absolute height. When the height control is performed based on the absolute height, a height at which the conveyance device 1 moves or a height at which the conveyance device 1 hovers is set based on an absolute height of a place where the conveyance device 1 is used. Then, even when the ground surface of the place where the conveyance device 1 is used is uneven or the conveyance device 1 moves above an aerial ground surface, the conveyance device 1 can be horizontally moved and thus the conveyance device 1 can be stably moved.

Here, when the height control is performed based on the absolute height, the conveyance device 1 cannot be moved over a sloped surface, stairs, or the like. That is, when the conveyance device 1 is moved along a sloped surface, stairs or the like, a distance between the sloped surface or stairs and the conveyance device 1 gradually decreases, and eventually the conveyance device 1 collides with the sloped surface or stairs.

Therefore, it is desirable that the height control can switch between being based an absolute height and being based on a height above the ground depending on an environment in which the conveyance device 1 is moved or is put in a hovering state. For example, when the conveyance device 1 is moved over a place where flat ground surface continues or is moved above a water surface of a river or a lake or the like, the absolute height can be used for the height control and the conveyance device 1 can be stably moved. On the other hand, in the case where there is a sloped surface, there are stairs, there is an obstacle to go over, or the like, the relative height can be used for the height control and the conveyance device 1 can be reliably moved.

Such switching may be performed by an operator using a switching switch according to the environment in which the conveyance device 1 is used, or may be automatically performed by comparing an absolute height and a height above the ground that are measured. For example, when a difference between the absolute height and the height above the ground is small (in other words, is within a predetermined range), the height control can be performed using the height above the ground, and the conveyance device 1 can be moved along the ground surface. On the other hand, when the difference between the absolute height and the height above the ground is large (in other words, is larger than the predetermined range), the height control can be performed using the absolute height and a rapid change in the height of the conveyance device 1 can be prevented. In this case, it is necessary that a value obtained by adding to the height above the ground an absolute height of a ground surface of the place where the conveyance device 1 is used is compared with the absolute height.

Further, when the conveyance device 1 has both a sensor that measures the absolute height and a sensor that measures the height above the ground, versatility is increased. However, when an environment in which the conveyance device 1 is moved or is put in a hovering state is limited, it is possible to provide only a sensor that allows the height control suitable for the environment to be performed.

A method or a sensor for measuring the absolute height is not particularly limited. For example, a barometer or the like can be used but it is not particularly limited.

### (Control of Hanging Load)

In the above example, a case is described where an object to be conveyed by the conveyance device 1 of the present embodiment is placed on the mounting part CA on the upper surface or the like of the cover frame 6. However, when the object is conveyed by the conveyance device 1 of the present embodiment, for example, it is also possible to hang the object to the conveyance device 1 using a wire or the like.

In this case, when the conveyance device 1 starts to move or stops, due to inertia, moving or stopping of the object may lag behind the moving or stopping of the conveyance device 1. When the conveyance device 1 starts to move or stops, swinging of the object may occur and, due to the swinging, it is possible that the posture of the conveyance device 1 becomes unstable.

Therefore, when the object is moved by hanging it to the conveyance device 1, the controller 11 may control the movement of the conveyance device 1, that is, the actuation of the four lift sources 2 such that swinging of the object is prevented.

A control method to prevent swinging of the object is not particularly limited. For example, when the movement of the conveyance device 1 is controlled using a method proposed by Sonobe et al in “Study on Simple Vibration Control for Small-Size Helicopter with Slung Load System” (TRANSACTIONS OF THE JAPAN SOCIETY OF MECHANICAL ENGINEERS (Series C, Vol. 78, No. 789)), the swing of the object when the conveyance device 1 starts to move or stops can be suppressed.

As described above, when the object is hung to the conveyance device 1 using a wire or the like, a hanging member such as the wire or the like corresponds to a holding part in the claims.

### (About Horizontal Movement)

Further, in the above example, when the conveyance device 1 moves in the horizontal direction, the conveyance device 1 is inclined and thereby generates a thrust force. However, when a member such as a vane that controls flow of air flow is provided below the device, specifically, below each of the lift sources 2 (that is, below an outlet of each rotor), it is possible to deflect the thrust force. For example, by providing the vanes, a direction of a blowing-out flow can be changed as in the case of a rudder or an elevator of an airplane. Therefore, the thrust force can be deflected. Then, the conveyance device 1 can gain a horizontal thrust force without having to have its body inclined. Therefore, the conveyance device 1 can move while maintaining its posture horizontal. In this case, by controlling operations of the vanes or the like according to a direction and a magnitude of an external input force (or force input from an external), the conveyance device 1 can be moved in a direction in correspondence to the input force over a distance (or a time period) in correspondence to the input force while maintaining the body of the conveyance device 1 horizontal.

### INDUSTRIAL APPLICABILITY

The conveyance device of the present invention is suitable for a dolly or the like that three-dimensionally conveys an object or conveys an object to a high place.

### DESCRIPTION OF REFERENCE NUMERALS

1: conveyance device

2: lift source

2a: rotary wings

2b: motor

5: frame body

5a: beams

6: cover frame

6h: rotor accommodating parts

10: control part

10a: sensor

11: controller

12: input part

12a: sensor

CA: mounting part

1-11. (canceled)

12. A control method for a flight vehicle having a plurality of lift sources, the control method comprising:
switching, according to a command input force from external, a control function of the flight vehicle between
a stationary control function that maintains a hovering state of the flight vehicle by controlling actuation of the lift sources, and
a moving control function that detects the command input force to the flight vehicle and controls the actuation of the lift sources to realize movement of the flight vehicle in correspondence to the command input force.

13. The control method for the flight vehicle according to claim 12, wherein
the switching the control function of the flight vehicle includes two steps below:
i) shifting from the stationary control function to the moving control function when the command input force, which is an input force greater than a predetermined value, is detected, and
ii) shifting from the moving control function to the stationary control function after the movement of the flight vehicle corresponding to the command input force is completed.

14. The control method for the flight vehicle according to claim 12, wherein
the command input force to the flight vehicle is a force that changes a posture of the flight vehicle in the hovering state.

15. The control method for the flight vehicle according to claim 12, wherein
the stationary control function controls the actuation of the lift sources to maintain the hovering state by PID control.

16. The control method for the flight vehicle according to claim 15, wherein
the moving control function controls the actuation of the lift sources to maintain the posture of the flight vehicle by PD control.

17. The control method for the flight vehicle according to claim 12, wherein
the moving control function controls the actuation of the lift sources according to at least one of a magnitude and a direction of the command input force.

18. A conveyance device that is a flight vehicle, comprising:
a holding part that holds an object to be conveyed,
a plurality of lift sources, and
a control part that controls actuation of the lift sources, wherein
the control part performs:
a stationary control function that maintains a hovering state by controlling the actuation of the lift sources;
a moving control function that controls the actuation of the lift sources to realize movement of the conveyance device in correspondence to a command input force from external; and
a switching function that switches control of the conveyance device from the stationary control function to the moving control function according to the command input force from the external.

19. The conveyance device according to claim 18, wherein
the command input force for the actuation of the lift sources is a force that is input to the conveyance device by a physical contact from the external.

20. The conveyance device according to claim 19, wherein
the command input force that is input by the physical contact affects a posture of the conveyance device in the hovering state.

21. The conveyance device according to claim 19, wherein
the stationary control function controls the actuation of the lift sources to maintain the hovering state by PID control, and
the moving control function controls the actuation of the lift sources to maintain the posture of the conveyance device by PD control.

22. The conveyance device according to claim 19, further comprising
an input detection part that detects the command input force that is caused by touching the flight vehicle, wherein
the moving control function controls the actuation of the lift sources according to at least one of a magnitude and a direction of the command input force that is detected by the input detection part.

23. The conveyance device according to claim 18, wherein
the control part further has a GPS function that grasp a position of the conveyance device,
when the hovering state is maintained by the stationary control function, a signal from the GPS function is used to control the actuation of the lift sources, and
when the conveyance device is moved by the moving control function, the actuation of the lift sources is controlled without using the signal from the GPS function.

24. The conveyance device according to claim 18, wherein
the conveyance device is a multi-rotor helicopter of which the lift sources are a plurality of rotors,
the conveyance device includes
a cover frame that has rotor accommodating parts for accommodating the rotors; and
a frame body that supports the cover frame, and
the frame body has a plurality of beams, one end of each of the beams being connected to an outer edge of the cover frame, and other ends of the beams being connected with each other.

25. The conveyance device according to claim 18, further comprising:
a positional sensor that detects a position of the conveyance device, wherein
the control device determines one of a target movement distance and target movement time based on the command input force, and
the switching function that switches the control of the conveyance device from the moving control function to the stationary control function when the control device detects that the conveyance device moved either the target movement distance or for the target movement time.

26. The conveyance device according to claim 18, wherein
the switching function that switches the control of the conveyance device from the moving control function to the stationary control function when the control device detects that the command input force became smaller than a predetermined value.
